(19) United States
(12) Patent Application Publication
(10) Pub. No.: US 2025/0330864 A1
(43) Pub. Date: Oct. 23, 2025

(54) 5G WORKLOAD TO CLOUD ASSIGNMENT FOR PERFORMANCE IMPROVEMENT AND POWER MANAGEMENT USING ARTIFICIAL INTELLIGENCE AND DEEP LEARNING

(71) Applicant: AT&T Intellectual Property I, L.P., Atlanta, GA (US)

(72) Inventor: Satya B. Vardharajan, San Diego, CA (US)

(21) Appl. No.: 18/640,128

(22) Filed: Apr. 19, 2024

(51) Int. Cl. H04W 28/02; H04W 24/08

(52) U.S. Cl. CPC H04W 28/0268; H04W 24/08

(57) ABSTRACT

Aspects of the subject disclosure may include, for example, collecting network performance information about a network, the network comprising a first plurality of network edge cloud nodes and a second plurality of service regions, wherein a service regions of the second plurality of service regions provides mobility network communication services to end users located in the service region, the end users accessing radio access networks (RAN) serving the respective service region of the second plurality of service regions, wherein the network edge cloud nodes are configured to process core network traffic associated with one or more respective radio access networks, in compliance with a set of key performance indicators (KPIs) for network performance for the second plurality of service regions, and automatically allocating selected respective service regions to one or more designated network edge cloud nodes with the goal of achieving KPI compliance for the respective service regions. Other embodiments are disclosed.

### FIELD OF THE DISCLOSURE

The subject disclosure relates to improvements in network performance including dynamically matching network equipment with network demand and matching active network equipment with network demand, as well as on-demand reduction in power consumption by network elements.

### BACKGROUND

Network operators are deploying equipment for next-generation communication networks. Such equipment makes use of creative solutions to accelerate performance in the network core in order to support next-generation services that require low-latency, high-mobility, ultra-reliability and high-capacity in the network. However, available network capacity and capabilities may not be available where needed at any given time. Moreover, when excess capacity at a location exists, the equipment required to provide such capacity can require substantial power and cooling to remain available for deployment.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a block diagram illustrating an example, non-limiting embodiment of a system functioning within the communication network of FIG. 1 in accordance with various aspects described herein.

FIG. 2B depicts an illustrative embodiment of a method in accordance with various aspects described herein.

FIG. 2C is a block diagram illustrating an example, non-limiting embodiment of a system functioning within the communication network of FIG. 1 in accordance with various aspects described herein.

FIG. 2D depicts an illustrative embodiment of a method in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for automating the assignment of workloads in a mobility network such as fifth generation cellular (5G) cellular networks and subsequent generation networks, from service areas to network edge cloud (NEC) nodes that are best suited to handle the workloads based on comprehensive analysis using performance and load models and application of artificial intelligence and deep learning along with artificial neural network ANN techniques. Other embodiments are described in the subject disclosure.

One or more aspects of the subject disclosure include collecting network performance information about a network, the network comprising a first plurality of network edge cloud nodes and a second plurality of service region devices, wherein service region devices of the second plurality of service region devices are configured to provide mobility network communication services to end users located in regions associated with the service region devices, the end users accessing radio access networks (RAN) served by respective service region devices of the second plurality of service region devices, wherein the network edge cloud nodes are configured to process core network traffic associated with one or more respective radio access networks, determining a set of key performance indicators (KPIs) for network performance for the service region, and automatically allocating selected respective service region devices to one or more designated network edge cloud nodes to satisfy one or more KPIs of the set of KPIs for the respective service region.

One or more aspects of the subject disclosure include determining respective mobile communication traffic workloads in respective network portions of a communication network, the communication network including service region devices establishing a radio access network to provide mobility network services to users in regions served by the service region devices, determining current capacity of core network equipment of the communication network, the core network equipment including a plurality of network edge cloud nodes configured to provide core network services to the users in the regions, wherein each service region is allocated to one or more network edge cloud nodes, and determining current network key performance indicator measurements for communication traffic at the respective portions of the communication network due to the respective communication traffic workloads in the respective network portions. Aspects of the subject disclosure further include reallocating a service region from a current network edge cloud node(s) to an available network edge cloud node based on available current capacity of the available network edge cloud node to maintain the current network key performance indicators at acceptable values.

One or more aspects of the subject disclosure include monitoring current communication traffic load and of the network edge cloud including a plurality of network edge cloud nodes providing core network functions for the mobility network, wherein each service region is allocated to one or more network edge cloud nodes for processing communication traffic of the each service region, identifying possible traffic consolidations of network communication traffic on selected network edge cloud node equipment to enable powering down unneeded network edge cloud equipment, powering up selected network edge cloud equipment to begin processing communication traffic of the current communication traffic load, shifting the current communication traffic load on the selected network edge cloud equipment, including monitoring key performance indicators for the current communication traffic load, and selectively powering down the unneeded network edge cloud equipment to reduce overall power consumption by the network edge cloud equipment.

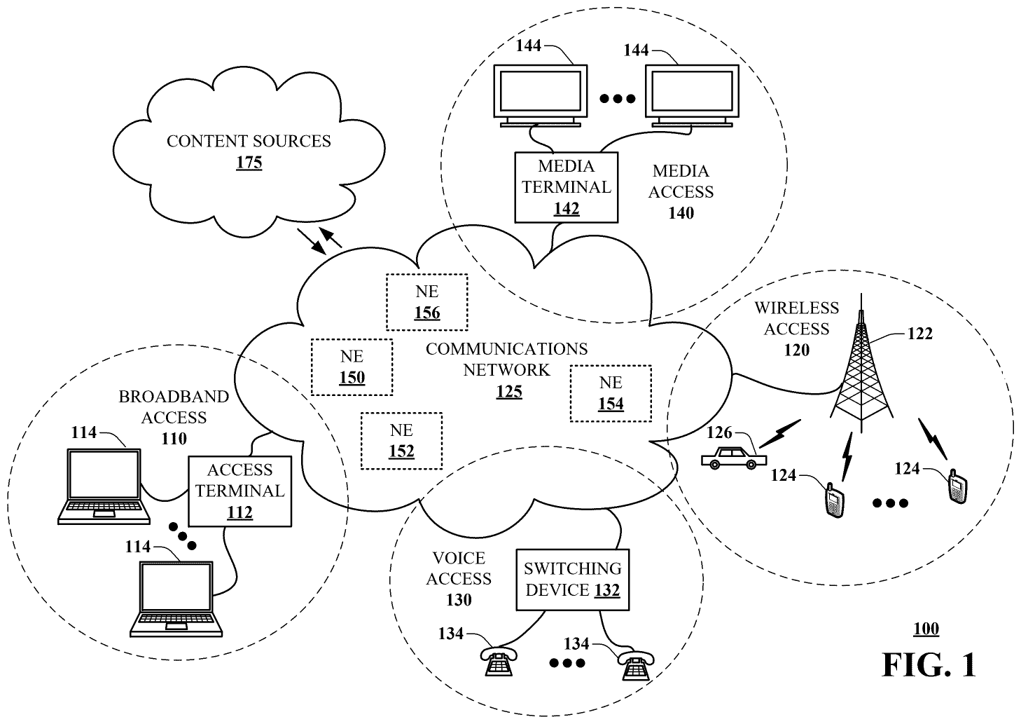

Referring now to FIG. 1, a block diagram is shown illustrating an example, non-limiting embodiment of a system 100 in accordance with various aspects described herein. For example, system 100 can facilitate in whole or in part <tie to a few of the main features of the claims>. In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

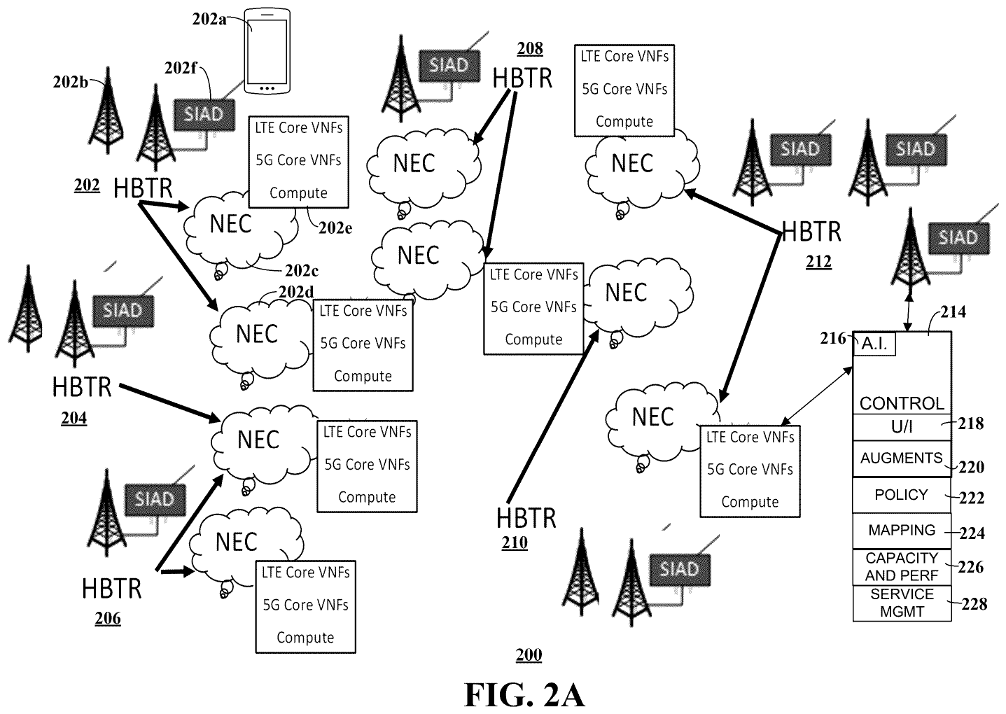

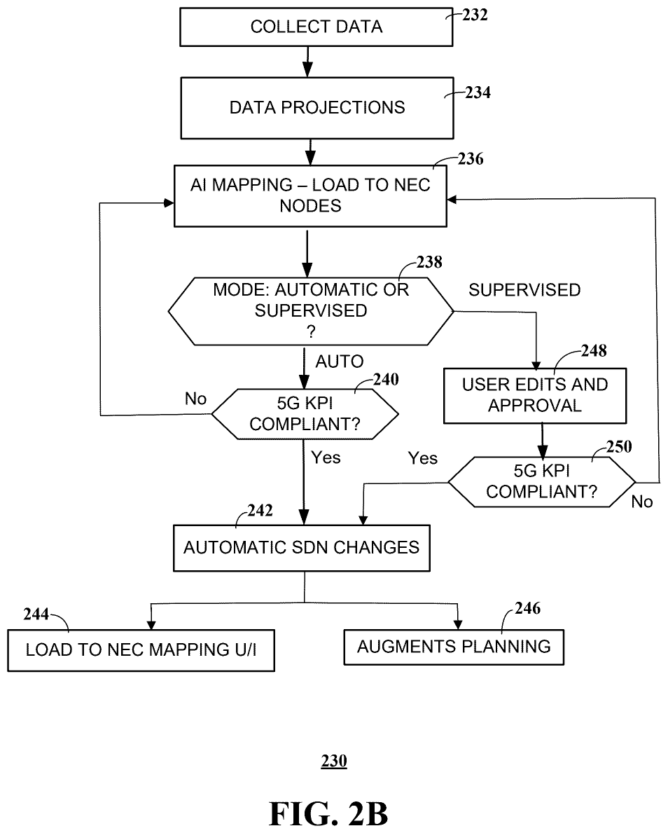

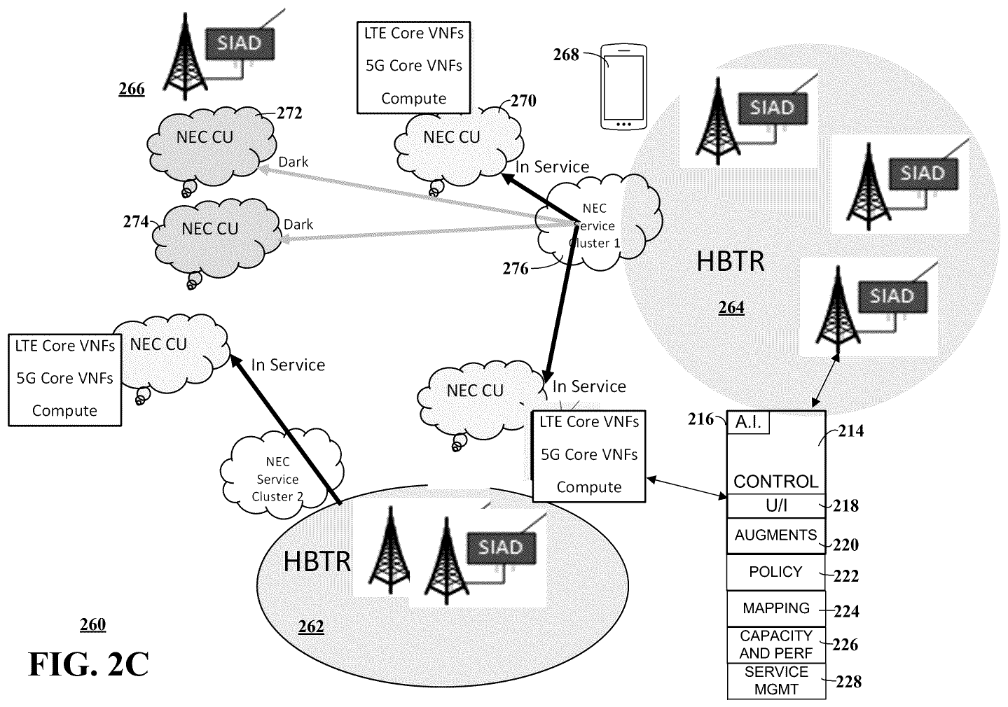

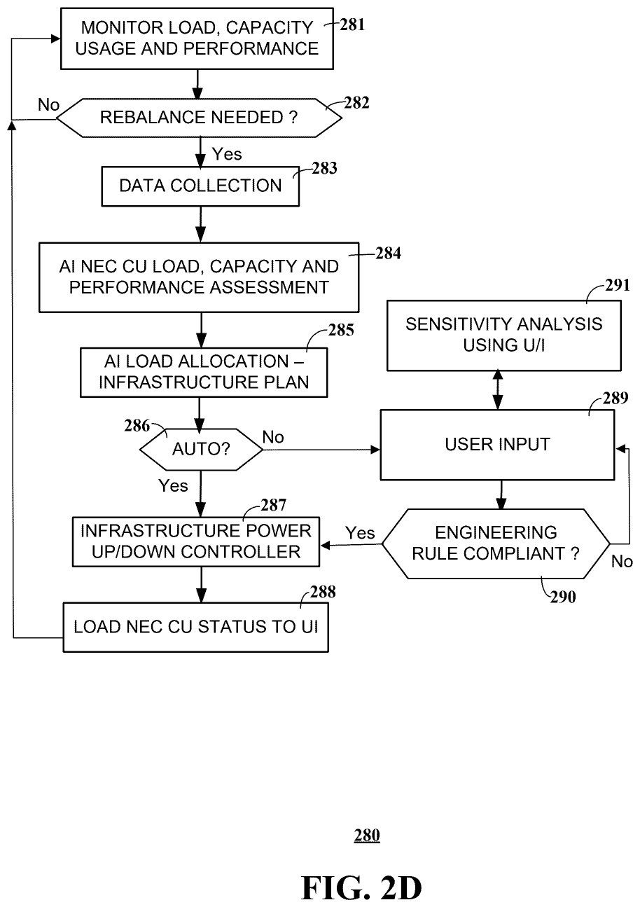

FIG. 2A is a block diagram illustrating an example, non-limiting embodiment of a system 200 functioning within the communication network of FIG. 1 in accordance with various aspects described herein. The system 200 includes a portion of a wireless network such as wireless access 120 of FIG. 1. In the illustrated embodiment, the wireless network is divided into a plurality of portions, each portion services a particular region. Thus, the system 200 includes a first subnetwork 202, a second subnetwork 204, a third subnetwork 206, a fourth subnetwork 208, a fifth subnetwork 210 and a sixth subnetwork 212. The system 200 may include more or fewer subnetworks or portions. The example of FIG. 2A is intended to be exemplary only. The regions served may be geographical regions or they may be defined in any suitable manner, such as by subnet address, by customers or type of customers served, by wireless technology or available features, or otherwise.

First subnetwork 202 will be described in additional detail. The description of first subnetwork 202 is intended to be exemplary of the other subnetworks of system 200. In the example, first subnetwork 202 is configured or operates as a high byte tracking access code (TAC) region or HBTR. The HBTR corresponds to a geographical region where the first subnetwork 202 is located. Traffic for a session between the network and an end user such as smartphone 202a is labelled with a data element corresponding the geographical region of the HBTR. A high byte in an identifier is sent across during session initiation that identifies sessions that are all coming from a particular region. The identifier regionally associates the traffic and, in that way, in the cellular core network, as traffic is processed, the region where it originates is known.

The first subnetwork 202 provides communication services to users and user devices such as smartphone 202a. In general, the subnetwork 202 establishes a radio access network (RAN) providing radio communication with users such as the smartphone 202a according to a published air interface standard, such as the fifth generation (5G) cellular standard. The subnetwork 202 includes a number of base stations such as base station 202b. The base stations may also be referred to as eNodeB devices or eNodeG devices. Any suitable number of base stations such as base station 202b may be implemented in the HBTR to provide mobility and radio communication services to users on the first subnetwork 202.

In the example embodiment, the base stations including base station 202b of the first subnetwork 202 are in data communication with one or more network edge cloud (NEC) nodes such as NEC node 202c and NEC node 202d. Thus, the base stations associated with the region designated as an HBTR are further associated with the one or more NEC nodes. In this illustrated example, the HBTR defines a geographic region such as “San Diego” or “Western Washington.” However, any suitable portion or subnetwork may be aggregated together as subnetwork 202. The base stations and other equipment of the HBTR thus service the geographic region defined by or associated with the HBTR.

The base stations and other equipment of the HBTR thus form a plurality of service region devices. The service region devices of the plurality of service region devices are configured to provide mobility network communication services to end users such as smartphone 202a located in regions associated with the service region devices. The end users may access radio access networks (RAN) served by respective service region devices such as the base station 202b of the plurality of service region devices. The first subnetwork 202 includes a scalable increase, adaptive decrease (SIAD) device 202f in FIG. 2A which operates as an aggregation point for managing congestion in networks with high speed and low latency, in particular for traffic coming in from the RAN from the cell tower or base station 202b.

The NEC nodes including NEC node 202c and NEC node 202d form a plurality of network edge cloud nodes. The NEC nodes are in data communication with the base stations of the HBTR. For example, the NEC nodes may be coupled over Ethernet connections or fiber optic networks to the base stations of an HBTR. The network edge cloud nodes are configured to process core network traffic associated with one or more respective radio access networks such as the RAN served by the base stations such as base station 202b.

In 5G cellular systems, many functions are located in and performed in a core network. Such functions include a user plane function (UPF), a session management function (SMF), an access and mobility management function (AMF), a policy control function (PCF), a network exposure function (NEF), and others. The 5G architecture generally makes use of a service-based architecture with cloud-native flexible configurations of network functions, such as those listed here. The network functions may be loosely coupled and may be deployed as independent, containerized services.

Wireless operators are rapidly deploying 5G Services worldwide. Advantages offered by 5G services include low latency, super-fast performance to enable increasing number of mission critical (reliable), real time (low latency), highly mobile (high availability) and high bandwidth (high capacity) applications like autonomous driving, industrial automation and internet of things (IoT) applications. Service providers use creative solutions to accelerate performance in the network core in order to support such low latency 5G services. Virtual network functions (VNFs) running on network edge cloud (NEC) nodes such as NEC node 202c and NEC node 202d are part of this solution. Such VNFs enable rapid delivery of 5G services to end users such as the smartphone 202a.

Thus, as illustrated in the example of FIG. 2A, the NEC nodes such as NEC node 202c implement a variety of core elements 202e such as virtual network functions (VNFs). These may include fourth generation cellular (LTE or 4G) core VNFs and 5G core VNFs, such as those listed above and others. Further, the NEC node may implement other functions such as data processing and compute services.

Conceptually, the network infrastructure forms an underlay. The network infrastructure includes base stations, NEC nodes and connecting links, all set up to handle a workload of traffic in the network. The 5G workload forms an overlay of the network. The workload includes user data such as data between an application operating on a user device such as smartphone 202a and a web site accessible over the public network. The workload includes user data such as voice data for a voice call. The 5G workload includes control plane data such as data to set up and manage a session for a user device.

To maximize 5G performance, high-speed, low latency, connections may be used between the base stations and compute elements and other core elements 202e that will handle the workload from 5G components. Lower latency better serves many 5G applications such as internet of things (IoT), autonomous driving, and industrial automation. Such applications require low latency.

To improve latency and other performance parameters, the system 200 includes edge compute or the network edge clouds such as NEC node 202c and NEC node 202d. In embodiments, the NEC nodes are physically located right where the collectors from the SIAD device 202f bring in network traffic. For example, the network edge clouds may be located at the central office as the mobility transport switching office (MTSO) for the mobility network, as physically close to the base stations and the RAN as possible. This is in contrast to a conventional arrangement in which the compute nodes are at a data center or other remote compute element which may take several router hops to access over the network.

Further, in embodiments, core network functions are implemented on the NEC nodes such as NEC node 202c and NEC node 202d. In some cases, the NEC nodes are located right at the edge of the mobility network so that, as the traffic comes in from the RAN and within a single router hop or so, the traffic is at the cloud edge compute cloud where there are core elements like 5G core elements available to handle the workload. Further, any response for traffic control or routing or other purposes is also returned to the 5G RAN area within a single hop.

Thus, the 5G core processing is handled by virtual network functions operating on shared infrastructure, the NEC nodes. The core functions are located in close proximity to the 5G RAN networks to provide minimal latency and optimal performance for high speed, low latency applications of the 5G network.

Performance and optimal performance may be defined in any suitable manner. For 5G network communications, one definition for performance is provided by key performance indicators or KPIs. Any suitable KPIs may be selected for evaluation, improvement, and optimization. Example KPIs include data throughput, latency, bandwidth, and jitter. Data throughput corresponds to the amount of information or data transferred in a given amount of time. Related measures are the speed with which a specific workload can be completed and a response time, or the amount of time between a single user request and a receipt by the user of the response, e.g., to load a video. Throughput may be measured as Megabits per second, or Mbps, for example. Latency is a measure of the amount of time for data such as a packet to get from the user equipment to the content server via the 5G core NEC and back, or a similar round-trip time. Bandwidth refers to a data transfer rate of a wireline or wireless network communications link to transmit between identified points. Bandwidth may be measured in bits per second. Jitter includes the variation in time delay between when a signal is transmitted and when it is received over a network connection.

A set of 5G KPIs may be used as a standard for network performance in the system 200. In embodiments, the system 200 operates to ensure that the overlays created by the 5G workloads are always handled by the network in a way that is compliant with all 5G KPIs. Any appropriate or suitable KPIs may be chosen or specifically defined for evaluating network performance, including data throughput, latency, bandwidth and jitter. Other KPIs may be chosen in addition or instead.

In embodiments of the system 200, the NEC nodes are located at various locations. The locations may provide service to one or many HBTRs. There may or may not be a one-to-one ratio or mapping for NEC cloud elements for an HBTR. In other regions, there may be a one-to-many mapping in which a large HBTR such as San Francisco or Dallas has a cluster of NEC nodes or multiple clusters of NEC nodes called a serving cluster. In the example of first subnetwork 202, the HBTR maps to NEC node 202c and NEC node 202d.

NEC node 202c and NEC node 202d may be considered to be a part of a serving cluster. A serving cluster generally will include individual cloud nodes that include switching elements, firewall elements, storage elements, and compute elements. Moreover, the cloud nodes generally have cloud software for performing cloud functions. The hardware and software together determine the capacity of these elements to handle 5G workload.

The HBTRs are allocated to one or more NEC nodes. In conventional networks, the allocation is handpicked by a network engineer or technician. The network engineer considers real-time operating conditions such as load and available capacity of individual NEC nodes and clusters of nodes. The network engineer considers the capacity and loading of shared network elements such as access and core links between the HBTRs and the NEC nodes, and among other network points. For example, the network engineer may monitor network performance attributes such as latency, route miles, jitter, throughput, packet loss, response time, transactions, data volume, etc. that help to understand if core performance of transport and cloud infrastructure can handle incoming 5G workload to satisfy defined 5G KPIs.

Further, the network engineer considers capacity and loading and determines which nodes are best suited to handle a 5G workload. Network traffic including 5G traffic will traverse shared network links (access links, aggregation links, and core links) to reach the VNFs running on the NEC nodes. Capacity on these shared links needs to be carefully managed to ensure high performance. NEC nodes are generally deployed right at the edge of the service provider's network to enable proximity routing of 5G traffic and to deliver lowest latency to the VNFs. Capacity consumption trends inform the network engineer on how to handle 5 G workloads and what augments may be needed and by when.

Further, NEC-VNF performance depends on cloud node capacity, including hardware and software. In addition, a VNF software version should also be managed carefully to ensure peak performance. NEC maintenance plans for hardware or software faults or upgrades can also have an impact on available capacity to service incoming 5G workloads. Further, sometime network equipment must handle special events which greatly increase network traffic for a limited time period. Such special events may include scheduled special events such as a sporting event, concert or other gathering. Such special events may include unscheduled events such as an emergency like a fire or severe weather emergency that may increase traffic but decrease or disable some network available capacity or features.

As noted, currently assignment of 5G workloads from a HBTR to NEC nodes is conventionally done manually. However, with increasing number of NEC nodes being deployed in and nearby the HBTR regions, it becomes a very complex and time-consuming task to manually assign HBTR 5G workloads to NEC-VNFs, fully cognizant of all performance and capacity data, special events plans and maintenance plans, so that each HBTR experiences the best 5G performance that meets or beats established 5G KPIs. The overlay, which is the workload, must be matched with the underlay which is the network infrastructure. As the workload increases in volume and complexity, the matching becomes too great a task for manual implementation.

Describing additional features of the exemplary embodiment of FIG. 2A, the system 200 includes a control unit 214. The control unit 214 may implement a load allocator to manage assignment of workload to network elements for processing. The control unit 214 in the example includes an artificial intelligence module 216, a user interface 218 or U/I, and an augmentations module 220. The control unit 214 including the load allocator function may be implemented on any suitable data processing system including one or more processors and a memory for storing data and instructions. In an example, the load allocator of the control unit 214 may be implemented using spare capacity of an available NEC node.

The artificial intelligence (AI) module 216 may implement any sort of AI process or machine learning algorithm or combination of such processes and algorithms. In an example, the AI module 216 implements an artificial neural network with deep learning to design an allocation plan for the system 200 that satisfies all relevant 5G KPIs. The AI module 216 may further implement machine learning models and may receive any suitable data as training data.

In embodiments, the AI module 216 develops projections of available capacity in the network infrastructure and projections of workload in the RAN served by the HBTR. These projections may be based on artificial neural networks and deep learning and may be developed based on access to historical data for network operation, scheduling data for network outages and other activity, calendar information of network personnel responsible for network operation and maintenance as well as communication resources such as emails and instant messaging of such network personnel. Any available source of information may be tapped to develop the necessary projections of infrastructure capacity consumption and HBTR workload. Moreover, as additional information becomes available, the projections may be updated and refined for use in developing a network allocation plan by the load allocator.

The user interface 218 may be accessed by a user such as network personnel or a network engineer to interact with some or all aspects of the system 200. The user interface 218 may be operative to provide a graphical display showing relative loading and relative capacity availability in portions of the network. The user interface 218 may receive input from the user to control display of information, to control network components and other functions as well.

In embodiments, the task of matching workload to capacity, of matching the overlay to the underlay may be performed by a load allocator. The task may be automated and optimized by selecting a network portion such as a high-byte TAC region and considering available network edge cloud capacity and matching the two using 5G key performance indicators as a standard. If an allocation of HBTR traffic to one or more NEC nodes satisfies all relevant KPIs of a set of available KPIs, the allocation may be made by the load allocator.

Not all KPIs need to be satisfied. For example, in some applications such as vehicle-to-vehicle (V2X) communication, latency is a critical parameter. The standards which define 5G performance provide for ultra-reliable low latency communications (URLLC). In such as application, a KPI for packet loss or network jitter may not be as critical. Thus, the exact group of KPIs that must be satisfied may be selected by the load allocator or another source for each particular case. Moreover, s specific value and tolerance for a particular KPI may be specified by the load allocator or another source. For example, in the V2X example for URLLC, an acceptable or “pass” value of 50 ms may be established, with an exemplary tolerance of 5 ms, or a tolerance of ±5 ms, to satisfy the KPI for the application. In the example, a NEC node that offers an average tolerance of 53.5 ms will satisfy the KPI and will be acceptable, so HBTR traffic may be routed to that NEC node by the load allocator. The HBTR may be allocated to that NEC node.

Moreover, predictions of network workload requirements and capacity requirements may be made by the control unit 214 for any suitable period of time such as a month, a calendar quarter, six months, etc. The predictions may be based on historical workload/capacity information, scheduled maintenance, scheduled events in a region, and other information. The predictions may be used by the load allocator to allocate one or more HBTRs to one or more NEC nodes so that the allocation need not be changed during that time period.

Still further, the HBTR to NEC node allocation can be updated by the control unit 214 as the network changes. For example, an unplanned network outage may occur in which a portion of the transport network from a particular HBTR to an allocated NEC node becomes temporarily unavailable. In other cases, unplanned maintenance may require that a portion of the network be taken down, or an unscheduled event may occur that is likely to create a large flow of traffic. In some cases, the allocation may be changed by the load allocator on an ad hoc basis to accommodate the unexpected change in near-real time, to select another suitable NEC node that will enable satisfaction or relevant 5G KPIs. In other cases, an analysis could be done periodically by the load allocator or according to a time, operator request, or any other input. In the analysis, a set of next best HBTR allocations to NEC nodes may be designated and stored for subsequent access. In the event of a change in the network, the allocation information may be accessed and used by the control unit 214 to reconfigure and reallocate the network on a near-real time basis.

In some embodiments, after a match is made, the system 200 including the load allocator of the control unit 214 may operate in one of two modes, a supervised mode or auto mode and a manual mode. In a first mode, termed auto mode or automatic mode, the load allocator of the control unit 214 will automatically use an existing infrastructure mapping plan and use a software-defined network (SDN) interface to cooperate with various network elements to map HBTR workloads to necessary 5G core virtual network functions on the selected NEC nodes. 5G core functions include functions such as domain name system (DNS) servers, dynamic host configuration protocol (DHCP) servers, system architecture evolution (SAE) and/or mobility management entity (MME) gateways on one or more NEC nodes according to the plan. Then, when sessions come in from a high-byte TAC region, workload is mapped by various network elements to the mapped NEC node or serving cluster for provision of the selected 5G core service. The load allocation function automatically creates the necessary network pathway to provide the network service for the selected session in a way that is compliant with 5G KPIs.

Similarly, in the manual mode, a human interaction first reviews the automatically generated plan. For example, the mapping or allocation plan is provided to a network engineer or other personnel, such as by accessing network equipment such as the user interface 218. The network engineer can review and, if appropriate, modify the mapping or allocation plan. For example, the network engineer may have personal knowledge of some occurrence, such as an unplanned outage, in the network. If the network engineer modifies the mapping, the network engineer can submit the modified plan or mapping for automated assessment of the compliance with 5G KPIs. If such compliance is approved, the network engineer may forward the modified plan to a software-defined network controller for implementation. If compliance is not approved, the modified plan may be further modified, and a compliance check performed again. Modifications and verification may continue as long as necessary. The modified and approved plan is then used by the SDN controller for implementation.

Accordingly, under control of the load allocator, the allocation of regional network traffic in respective HBTRs may be optimized, taking into account current and planned workload, current and planned capacity, planned outages and high-traffic-volume periods, all from the various regions defined by the HBTRs. This can be done on an ongoing, near-real time basis to keep the system running very efficiently and to satisfy 5G KPIS that apply across the network and to individual users and to individual applications.

In some embodiments, the user interface 218 may be configured to use generative artificial intelligence (generative AI) features. For example, the control unit 214 or other processing system may implement a generative AI large language model. The model may be trained using capacity, performance, maintenance, and load data of the control unit 214 to derive user specific views of the detailed data. The model may be used to test potential mappings or modifications to existing mappings, and to test possible contingencies such a planned or possible network outage. The model may be accessed using prompts generated by the user using general language of the user. A large language model, trained on suitable training data, operates to answer the user or provide a user interface response for the user, according to the prompt. In one example, the user may enter, either by typing text or speaking into a microphone, “show me West Coast regions near the Super Bowl event that are going to be approaching noncompliance for storage.” The user interface 218 responds to the prompt by retrieving appropriate data, formatting the requested data, and generating an appropriate view or display for the user. Use of the large language model to receive user requests, review trained data and develop a suitable response greatly reduces the required training for human operators who must monitor and control network operations. The need to know particular menu operations and options, etc., is greatly reduced and simplified for a user. In addition, generative AI based systems are able to process numerous streams of workload, capacity, maintenance, and event data points to derive an accurate response for the user's query.

The generative AI based user interface 218 may clearly show 5G workload to NEC node mappings using data from the load allocator of the control unit 214. Further the user interface 218 can color code operational status of the mappings. For example, users can interact with the system 200 through the user interface 218 using generative AI to support capacity modeling and future augment plan development, for example. For example, based on user prompts, the user interface 218 can show different graphical views of potential mapping between HBTR devices and NEC nodes. In some embodiments, the user interface 218 can color code the display of a mapping. In this manner, the user interface 218 can clearly provide a visual indication of the status or compliance of a current mapping or a proposed mapping to show which ones are compliant with 5G KPI, which ones are approaching non-compliance and which ones are red non-compliant. In an example, a compliant mapping may be displayed graphically all in green; network branches or elements approaching non-compliance may be displayed in yellow; and non-compliant network branches or network elements may be displayed graphically in red. Any suitable color-coding and graphical presentation may be used. Similarly, other sensory notifications such as sounds may be provided by the user interface 218.

Through specific prompts using the user interface 218, users can interact with the Generative AI large language model to derive user-specific views of the detailed data. Further, at user request, this analysis could be conducted for different scopes of geography, such as local, regional, or national scope, and projected for different time periods in the future to assess continued compliance with 5G KPIs.

The user interface 218 enables a generative AI based approach to capacity modelling that delivers infrastructure capacity augment plans for increasing network capacity in selected locations. As network usage grows, capacity is consumed and infrastructure gets loaded. The network operator must maintain a service level agreement satisfying level of service and therefore must expand or augment the network capacity from time to time. A generative AI approach may be used to design or propose such capacity augmentations to the network. The proposals or plans are automatically generated with a goal of continued compliance with 5G KPIs. Using prompts, users can ask the generative AI large language model to deliver specific infrastructure augment plans including necessary costs, and associated timeline. In an example, the user can specify, “show me those sites where, within the next three months, the network must be augmented to retain six months’ of capacity compliant with 5G KPIs. Based on that construct of a user prompt, the augmentation module 220 is able to look at capacity data, performance, data load data and, with the artificial neural network and deep learning-based projections, the module can identify particular hot spots in the network likely to need augmentation. Further, the module can identify locations where the network operator should deliver the earliest augments to continue to remain compatible with 5G KPIs. Augments may include adding network branches, adding additional HBTR elements, for example, or adding additional NEC nodes or additional high-speed links among network elements. Augments may be based on specific engineering rules and use a deployment cycle time set up according to a predetermined policy. A proposed augments plan could then be displayed for interaction via the user interface 218. Further, this analysis could be conducted for different scopes of geography like local, regional, or national scope and projected for different time periods in the future to assess continued compliance with 5G KPIs. Still further, after viewing a proposed augments plan, the user could probe further possibilities, such as a predicted result of the network operator needs to delay a recommended augmentation by two weeks. What will happen?Other types of sensitivity analyses may be performed as well.

In embodiments, the control unit 214 or other data processing system may be divided into several functional modules. These include a policy module 222, which may operate to allow a user to set up key rules and thresholds to be followed to realize peak performance for 5G workloads. The policy module 222 in embodiments allows refresh of mappings globally, nationally, regionally or within a city, as desired by the operator. A mapping may relate to a one-time effort of a regularly recurring effort as configured in the policy module 222. For example, a performance model might vary in time, requiring a refresh with the consumption or augment of transport and cloud capacity. Similarly, as more subscribers and applications begin using the 5G service in an HBTR, its load model may require an update. Further, operations such as network maintenance or special events might also change available transport and cloud capacity. The system 200 enables rapid, comprehensive, and frequent re-optimization of 5G workload mapping now becomes possible due to a fully automated approach using artificial intelligence, deep learning and artificial neural network techniques.

A mapping module 224 uses these thresholds to shape mapping of the HBTR 5G Workloads to available NEC nodes. This may include network attributes such as round-trip time (RTT), response time, transactions rate, capacity headroom thresholds, good for interval values, capacity exhaust threshold, packet loss, capacity engineering rules, deployment cycle time, workload management mode (such as a supervised mode or an automatic mode), mapping refresh Interval, mapping refresh region etc. Any suitable combination of these network performance attributes, or others, may be used to manage a mapping by the load allocator of the control unit 214. Each network operator can then set up these values according to required 5G network performance. Further 5G KPIs may be defined in the policy module 222 so that delivered mappings successfully meet or beat required 5G KPIs.

A third functional module includes a capacity and performance module 226: The capacity and performance module 226 maintains the latest view of installed core-transport capacity and cloud capacity for each combination of mappings of the HBTR and NEC nodes. A user or a network operator may maintain or update any augments of capacity in the capacity and performance module 226. In addition, the capacity and performance module 226 may perform detailed measurements to keeps track of NEC available capacity for use by an HBTR. Further, using detailed measurements, the capacity and performance module 226 also maintains performance data for network attributes such as latency, route miles, jitter, throughput, packet loss, transactions, response time, data volume etc. for each HBTR to NEC node combination. Information about other network attributes, including historical data, may be maintained as well. Load data may also regularly be measured and maintained for attributes such as throughput, subscriber identity modules (SIMS), sessions, users, transactions, data volume, etc., for each HBTR or other network element. Trend information can be derived from time series data maintained on various capacity, performance and load attributes. The trend data is used by a mapping module to construct needed performance and load models using techniques including artificial intelligence, deep learning and artificial neural network techniques.

The mapping module 224 operates to use the list of HBTRs and a list of 5G NEC nodes to build a performance model for possible combinations of HBTR and NEC node. Time series data from the capacity and performance module 226 may be used to build such a performance model. The mapping module 224 also prepares a load model of incoming 5G traffic from each HBTR based on load time series data received at the mapping module 224. In embodiments, artificial intelligence, deep learning and artificial neural networks may be used to build projections of the capacity model and load model into the future and then predict how best to map HBTR 5G workloads to available NEC-nodes so that each HBTR 5G workload is processed compliant with 5G KPIs.

A service management module 228 is responsible for implementing the HBTR mappings to the NEC node as recommended by the mapping module 224. In embodiments, there may be two modes of operation. In a first, supervised mode, a service manager may review recommended mapping, make any changes desired and then approve implementation of the mappings. In a second, automatic mode, the load allocator of the control unit 214 may implement recommendations from the mapping module 224, for example, during a maintenance window. This service management module may interface with control plane devices defined according to a software network (SDN) and issue commands so that designated HBTR 5G traffic shifts to its corresponding recommended NEC nodes and provides confirmation of a successful change. The service management module 228 may only implement changes that are needed based on what already exists in the network and policy settings to minimize risk. Using the policy module 222, a regular refresh interval can be configured so that the load allocator of the control unit 214 can re-optimize HBTR 5G load to NEC mapping periodically and for selected geography.

A user interface (UI) module 218 graphically displays assignment of HBTRs to NECs in an intuitive manner for a human user. As noted, generative artificial intelligence techniques are used to train the UI module 218 on all pertinent engineering rules. In embodiments, performance data, capacity data, maintenance and load data, and user constructed prompts can drive functional details of the display of the user interface 218. In embodiments, an operator may derive deep dive views, using specially constructed prompts, into the performance model and the load model from the user interface 218 and further look at underlying performance, capacity, load and maintenance data to identify causes of non-performance. In further embodiments, the operator can use the user interface 218 to request a future projection using a date in the future to see how long current mappings will stay compliant or become non-compliant with 5G KPIs.

An augments module 220 may be a generative AI-based module configured to perform an analysis on capacity augments needed. Capacity augments are modifications or additions to the network, a network branch or network components that have the benefit of increasing capacity a selected portion of the network. Inputs to the augments module 220 include factors such as good-for interval and a specified geography. Any suitable information including generative AI techniques may be used to train the augments module 220 on engineering rules, pertinent performance, capacity, maintenance, events and load data. User-constructed prompts can derive output augment plans for transport and cloud capacity necessary to continue meeting established 5G KPIs in a given good-for Interval, such as three months, six months, etc., and geography. The augments module 220 may generate recommendations that also include completion dates in order to prevent any combination of HBTR 5G workload to NEC node from not meeting established 5G KPI. In embodiments, any augment shall be kept updated in the application using the capacity and performance module to keep the installed capacity view accurate.

The system 200 enables managing and optimizing very large and growing communication networks. In an example, the network may include 250 edge cloud nodes and thousands of HBTRs located across a broad range of geography. Such analysis and optimization cannot be done manually any longer. But deep learning with artificial neural networks may be applied to the problem. The AI tools can identify existing capacity and workload and project future workload and capacity. The AI tools can account for factors such as maintenance taking network components offline, either on schedule or randomly. The AI tools can accommodate a special event in a particular region. The cloud nodes may be deployed at the edge of the network to take advantage of proximity and low latency routing to deliver excellent performance for 5G workloads. Using the disclosed technique for matching the 5G workloads to the network infrastructure allows the network to be flexible to maintain that excellent performance.

Accordingly, the system 200 operates to provide a deep learning approach to matching 5G workloads to 5G core functions which are implemented by network edge cloud nodes or other cloud elements. By iterating across the network, the network structure is optimized by using artificial intelligence techniques.

FIG. 2B is an illustrative embodiment of a method 230 in accordance with various aspects described herein. The method 230 may be used in conjunction with a communications network such as a 5G wireless network to automate the assignment of 5G workloads from a plurality of service region devices such as high-byte TAC regions (HBTRs) to best suited network edge cloud (NEC) nodes based on a comprehensive analysis using a performance model and a load models and by applying artificial intelligence, deep learning artificial neural network (AI/DL ANN) techniques to deliver best fit mappings.

At step 232, the method 230 includes collecting data. Any suitable data may be collected about the network including information about the devices present in the network and information about traffic on the network. The devices on the network may include base stations or eNodeB or gNodeB devices, core network elements, mobility network elements, NEC cloud elements routers and other devices. The devices on the network may include one or more network edge cloud nodes (NECs) which may be configured in a software-defined network to perform suitable functions. In particular, such functions may include 5G core functions. In embodiments, one or more NEC nodes is positioned in network proximity to the HBTR and the HBTR traffic is allocated to those NEC nodes. Locating the NEC nodes in network proximity to the HBTR improves performance of 5G applications that require low latency.

Examples of the information collected at step 232 include information about current and planned capacity of the network equipment, information about performance of the network equipment, information about planned and past maintenance of the equipment and events that may greatly increase or decrease traffic in the network. Also, information may be collected about a current and planned 5G loads in the network. A 5G load may be a load or other traffic which makes use of 5G features such as ultra-reliable low latency communication. Also, information may be collected about network locations of available NEC nodes that may be employed in the network. Any other suitable information may be collected at step 232 as well. Moreover, the data is collected over time, including historical data about past operations and configurations of the network, along with current status information. Such data is necessary for derivation of projections using ANN or deep learning operations.

At step 234, projections are made about events that may happen in the network. Such projections may relate to anticipated workload in the network including 5G workload, anticipated capacity consumption in the network, and anticipated performance in the network. Such projections may further relate to events in the network such as maintenance of equipment and software as well as seasonal or periodic events that may increase or decrease traffic in the network. The projections of step 234 may be based on any suitable information including the data and historical trend data collected at step 232. In embodiments, an AI process such as an artificial neural network performs the projections of step 234.

At step 236, the method 230 includes a process of mapping load to NEC nodes. In particular, an AI process such an artificial neural network maps 5G workloads from HBTRs of the wireless network to available NEC nodes to implement the required 5G functions. The mapping process may take into account aspects such as policies for tolerance for a particular performance parameter, such as network latency or throughput defined in the 5G KPI. Further, the mapping may take into account a policy for a duration for which the mapping should be valid, based on the projections of step 234. For example, if workload is doubling each month, and a policy calls for any satisfactory mapping to be valid for three months, the mapping must incorporate sufficient capacity to accommodate the growth.

The mapping of step 236 is performed according to one or more 5G key performance indicators. Any suitable KPI or combination of KPIS may be specified or used as a standard. Example KPIs include throughput and latency for a connection between a HBTR and an NEC node. As the AI process develops the map, the map is tested against the relevant KPIs to ensure that the mapping meets requirements. Thus, the mapping need not be the best mapping from a performance point of view. The mapping merely must comply with 5G KPI.

At step 238, one of two modes of operation is pursued. In an auto mode, the AI process chooses the best mapping according to any suitable standard. For example, the AI process may rank possible mappings based on the extent of 5G KPI compliance, strong or weak compliance. In another example, the AI process may choose the mapping that has the longest predicted duration for validity, before projected traffic requires a modification or re-mapping.

At step 240, the method 230 includes a further verification that the selected mapping is compliant with 5G KPIs. If not, control returns to step 236 to devise another mapping. If the mapping is compliant, at step 242, the software-defined network is redefined according to the new mapping. For example, internet protocol (IP) addresses for network components are updated to reflect the new mapping. The method 230, step 242, may include reconfiguring a domain name server (DNS) that stores information about assigned network locations, a mobility management entity (MME) of the wireless network that allows mobility session management for authentication and handover. Step 242 may further include interaction with a virtual slice selection function to select specific slice functions for the SDN. The operations of step 242 serve to change the mapping so that when the high byte TAC region shows up in a session attachment, the mapping directs the session to the newly selected NEC service cluster according to the new mapping.

At step 244, information about the mapping is loaded to the user interface of the device that may be accessed by a user. The user interface accesses the loaded mapping information when interacting with the user for selection of network features to present in graphical form or otherwise. Also, at step 246, the information about the mapping is loaded to an augments module which may be used for determining possible or predicted augmentations to the network. The augments module may use the information to respond to large language model prompts about current and future load and capacity in the network, etc.

If, at step 238, a supervised mode was in effect, at step 248, the mapping is presented to the user for approval. For example, the user interface module may receive the mapping information and present a graphical display which selectively highlights aspects of the workload and capacity in the network according to the model. The user may submit queries using a large language model to a generative AI model to explore, for example, robustness of the mapping or to investigate what-if possibilities. The user may make edits to the mapping based on individual or another knowledge. In one example, a HBTR may be reallocated from a first NEC node to a second NEC node by the user.

At step 250, the mapping is reviewed to determine if it is 5G KPI compliant. If not, control returns to step 236 to determine a new map. If the mapping is determined to be 5G compliant, control proceeds to step 242 to update information about how the network should handle sessions according to the new mapping. Step 244 and step 246 may be performed as described.

FIG. 2C is a block diagram illustrating an example, non-limiting embodiment of a system 260 functioning within the communication network of FIG. 1 in accordance with various aspects described herein. The system 260 may use artificial intelligence deep learning technology to understand the 5G workload trend in a selected market or region, understand the associated network edge cloud (NEC) infrastructure capacity forecast and usage as well as current performance. This information may in turn be used to keep in service only that NEC infrastructure capacity needed to handle current 5G workload while powering down remaining infrastructure capacity. This can beneficially reduce power and cooling consumption by network and compute components and extend device life of the powered-down devices.

In FIG. 2C, the system 260 includes a portion of a wireless network such as wireless access 120 of FIG. 1. In the illustrated embodiment, the wireless network is divided into a plurality of portions, each portion servicing a particular region. Thus, the system 200 includes a first HBTR 262, a second HBTR 264, and a third service area 266. The first HBTR 262 and second HBTR 264 and the third service area 266 provide wireless access to user equipment (UE) such as smartphone 268 in a designated area.

Considering the first HBTR 262 as an example, the first HBTR 262 includes several network edge cloud capacity units (NEC CU). In the example, this includes first NEC CU 270, second NEC CU 272 and third NEC CU 274. The first NEC CU 270, second NEC CU 272 and third NEC CU 274 are associated with a network edge cloud service cluster 276. Traffic from the second HBTR 264 is mapped to the service cluster 276 formed by a group of network edge cloud nodes. Each network edge cloud has a capacity unit or NEC CU. Each capacity unit may include, for example, ten servers, three or four switches and a load balancer, etc. A large zone served by a network may include, for example, 16 capacity units. Also, when the network operator augments the network, the augmentation is done by adding one or more capacity units, along with its constituent network elements.

NEC infrastructure is deployed at the edge of the service provider's network close to a HBTR market or region to handle the 5G workload for an HBTR such as the first HBTR 262 and the second HBTR 264. HBTR traffic is associated with or allocated to a NEC node and enabled by proximity routing. In such an implementation, information about the 5G workload, information about the NEC infrastructure capacity forecast and usage, along with information about the current performance, drive how much NEC capacity is deployed. Sufficient NEC capacity should be deployed to ensure adequate performance that meets 5G key performance indicators (KPIs).

As the network operator augments the network, capacity usage keeps climbing. At a predetermined threshold, such as 80 percent or 90 percent of maximum usage, the service provider augments the network with additional devices and additional capacity so as not to exhaust the overall available capacity. However, there are periods when usage is not that high, such as overnight. This creates an opportunity for reducing capacity according to usage. In embodiments, capacity usage data may be collected for the network along with load data for the network. Using deep learning, it can be determined how the load behaves over time, based on the collected data and past history. Similarly, using deep learning, it can be determined how the capacity usage behaves over time. Based on this information, an infrastructure plan can be developed to determine how many capacity units in a service cluster need to be in service at a given time and how many capacity units in the service cluster can be turned off or taken offline to reduce power consumption.

Preferably, this should be done in a graceful way, so there is some orchestration required if there is already some residual workload in capacity units that are marked for turn-down, that workload has to be transitioned instead in capacity units that will remain in service. With that orchestration, when the load is moved away, then the network operator can gracefully bring down the capacity units that are not needed for service. Subsequently, based on the capacity projections and load projections, if there is a need to bring one or more of the dark capacity units back into circulation, the network operator can do the reverse of the process where the dark capacity unit is brought back up and the existing workload is gracefully migrated and then it is in circulation and taking the workload in the in-service capacity units again.

The conventional NEC infrastructure represents substantial always-on, multi-core compute servers, high throughput equipment, including switches, servers, load balancers, firewalls, storage devices etc. Because network usage is dynamic, the NEC infrastructure remains fully powered to be available to be switched into use if needed. If an outage occurs elsewhere in the network, or equipment is intentionally taken offline for maintenance or another reason, the parked but powered-up NEC infrastructure stands ready to stand in for the offline equipment. This equipment consumes substantial power and requires cooling to regulate operating conditions while handling 5G workloads.

All of this always-on infrastructure consumes power and cooling, for which the service provider carries the cost. Based on the conventional methodology, the NEC infrastructure footprint only keeps growing and there does not exist a graceful and dynamic way to decrease NEC Infrastructure capacity which is not currently needed, without removing it from the network. Power and cooling consumption may vary with 5G workloads. However, there will continue to be a base level of consumption if equipment is always kept powered on even under low 5G workload conditions.

While service providers are good at monitoring NEC infrastructure usage and adding timely capacity augments, there does not exist a way to gracefully and dynamically decrease NEC capacity linked to decreasing 5G workload. Even when workload decreases in a known, predictable manner, such as overnight or on weekends, the infrastructure devices are generally maintained fully powered. As noted, this requires substantial power consumption, not just to power the infrastructure devices themselves but to cool them with air conditioning, fans, and other electrical equipment. A suitable plan to power down unneeded equipment would enable reducing power and cooling consumption, and potentially extending infrastructure life.

However, conventionally the only provision for powering-down an in-service device is decommissioning that device and removing it from the network. Decommissioning is typically driven by obsolescence of the equipment. For example, when 2G or 3G wireless equipment is no longer needed, it is powered down and power connections are removed along with communication lines to the equipment. The obsolete equipment may be left in place until the space is needed. At that time, the old, obsolete equipment is removed and replaced with current-generation equipment.

As explained herein, a system and method dynamically and gracefully power down NEC infrastructure which is currently not needed and brings it back online when needed. This introduces a concept of NEC infrastructure that is either “In Service” or “Dark,” based on 5G workload demand drivers. Further, this introduces the need to establish a graceful transition between the two states, for example by moving traffic from lightly used NEC devices to enable powering down those devices as not currently needed. This in turn will deliver operating cost savings and extend NEC infrastructure life which is an improvement over the conventional methodology of ever-increasing NEC footprint, consumption, and augments.

Network Edge Cloud (NEC) nodes are deployed at the edge of the network provider's network to handle 5G HBTR workload originating from locations in its network proximity. In a first layer of optimization each 5G HBTR workload may be mapped to the best-suited NEC capacity units that are in network proximity and have capacity to handle the 5G workloads. Network proximity may be defined by a number of router hops, such as three router hops. If an NEC node is within three router hops of the HBTR, it is within network proximity. Any suitable proximity standard may be used. This mapping of 5G workloads to NEC capacity units is done in a way so that 5G KPIs are satisfied. Commensurate with the size of a mobility market and its 5G workload, one or many NEC nodes may be involved in a serving cluster (SC) to handle the 5G workload of an HBTR. Each NEC node represents a capacity unit (CU) ready to serve the 5G workload. Augments are added to the network in increments of these CUs to expand the NEC footprint. This mapping process may be run at any suitable time interval such as periodically or through an ad hoc request in order to ensure performance conforms to 5G KPIs and efficient use of NEC infrastructure.

A second optimization may involve looking at each of the NEC SCs periodically (i.e., shorter intervals) to determine which CU in the SC needs to be kept in service and which can be powered down gracefully to conserve power and cooling. This process may also be run periodically (according to a network administrator-defined interval) or through an ad hoc request to conserve power and cooling while ensuring performance conforms to 5G KPIs and efficient use of NEC infrastructure. This second optimization may be run more frequently than the first optimization noted above to handle temporal variations of the 5G workload. The 5G workload may show variance based on time of day, month of year and special events like holidays, political events, commercial events, festival and functions, entertainment, and sports events, etc. In this manner, a graceful and dynamic way is provided to keep in service only those CUs in a SC that are currently needed, driven by an AI based data analysis and projections, powering down unneeded CUs and reducing power and cooling consumption leading to delivering cost savings and extending useful life of infrastructure. AI Data analysis and projections shall include 5G Workload, Capacity Usage, Performance, Maintenance and Special Events to drive an Infrastructure plan.

The system 260 may include a control unit 214 or other processing system for managing operation of the system 260. In embodiments, the control unit 214 or other data processing system may be divided into several functional modules. These include a UI module 218, an augments module 220, a policy module 222, a mapping module 224, a capacity and performance module 226, and a service management module 228. The operation of these modules may be similar to the operation described in conjunction with FIG. 2A.

FIG. 2D is an illustrative embodiment of a method 280 in accordance with various aspects described herein. The method 280 may be used in conjunction with efforts to understand the 5G Workload trend in a market or region, understand the associated NEC infrastructure capacity usage and forecast as well as current performance in order to keep in service only the NEC infrastructure capacity that is needed to handle current 5G workload while powering down remaining infrastructure capacity, thereby reducing power and cooling consumption. This may save costs for a network operator and prolong the service life for equipment. The method 280 may be performed at any suitable location in the network such as the control unit 214. The method 280 may be run continuously or may be initiated in response to any appropriate condition or input.

At step 281, the method 280 includes monitoring load, capacity, usage and performance in a mobility core NEC network such as the system 260 illustrated in FIG. 2C. In embodiments, the 5G workload is monitored including sessions that involve 5G activities or features such as URLLC communications, vehicle-to-vehicle communications or other communication that requires low latency, for example. Step 281 may include collecting information about usage of available capacity in the mobility core NEC network. Network activity may be monitored over an extended period of time, or the monitoring may be continuous in order to collect substantial data for artificial intelligence evaluation by a deep learning engine, for example. Moreover, the network activity may be assessed for with 5G key performance indicators compliance as part of the engineering rules established for the mobility core NEC network. Such engineering rules may include 5G KPI, best practices for reliably operating the network, such as specifying what headroom is needed in capacity for operation of the network, or a minimum duration before which a change could be scheduled, or what percentage of capacity (such as 85%) is permitted before triggering an augmentation to the network to handle additional capacity.

As shown in FIG. 2C, some capacity units of the mobility network may be in service and actively providing network communication services. Other capacity units of the mobility network may be dark or intentionally deactivated to a low power state to conserve power as being not needed at the time. At step 282, the method 280 determines is a rebalancing of in service and dark capacity units is required or appropriate. For example, if capacity usage in the network has increased above a threshold, it may be appropriate to power up one or more capacity units and bring them back online to handle the increasing capacity usage. This may occur also, for example, if one or more capacity units is purposely taken offline for maintenance or becomes otherwise unavailable. Similarly, if capacity usage is declining and the network usage is less than a threshold, it may be determined to take one or more capacity units offline as being unneeded. While evaluation in this example is based on capacity units, any suitable standard may be used, such as each network edge cloud node or compute server or other device.

At step 283, a data collection process occurs. For example, data about the current and historical 5G workload is collected for processing. Data about the current and historical NEC capacity usage and performance is collected for processing. Still further, data about any planned maintenance in the network affecting demand or usage or capacity is collected, along with any planned events that may affect traffic levels in the mobility network is collected.

At step 284, an artificial intelligence process such as an artificial neural network may perform an assessment of the load, capacity and performance at each NEC capacity unit. Further, the artificial intelligence process may determine which capacity units in the network are absolutely needed to process the current workload. Some additional overhead in capacity may be built into the determination so that the network has excess capacity in case of an unplanned outage or a surge in 5G workload, for example. Further, the method 280 may determine which capacity units are not needed and may be transitioned to dark state. If one or more devices are designated to be brought back online, those devices are selected or otherwise designated in the network.

This information or device designations may be used to determine an infrastructure plan. The infrastructure plan defines information such as which devices are dark and which devices are online, as well as allocating HBTRs, 5G workload to particular NEC nodes for 5G core processing. The infrastructure plan is developed to be consistent with existing engineering rules for the network. At step 285, the infrastructure plan is developed by the artificial intelligence process using deep learning-based projections of load and capacity usage.

At step 286, a branching is made depending on the operational mode of the method 280. If the mode is an automatic mode, at step 287, a controller operates to implement the infrastructure plan. This includes orchestrating load migration from devices which are designated to go dark to devices which are to remain or be powered on. Orchestrating the load may involve any suitable process to transfer processing of active sessions in the mobility network from a current device to a target device such as a target NEC node for handling 5G core functions. For example, a needed 5G function may need to be utilized on the target NEC to handle traffic reallocated from a current NEC.

Thus, the controller reorganizes and load balances through software defined networking (SDN) 5G workload on NEC nodes. Moreover, the reconfiguration using SDN techniques and the orchestration of the load migration is performed while continuing to satisfy the 5G KPIs in the network. Once traffic is migrated away from any unneeded capacity units, those capacity units may be powered down and taken offline.

At step 288, information about the status of the NEC capacity units is loaded to the user interface. This includes current information about what CUs are in service and what CUs are dark, as well as allocation information about what HBTR workload allocations to NEC CUs may be in place. In embodiments, the user interface uses a generative AI process. The users of the user interface can write prompts in natural language to request information about the current status in terms of each service cluster, including which capacity units or NEC nodes are active and in service and which NEC nodes are dark. In embodiments, the user interface may produce a graphical display using color coding and other graphical techniques to clearly show to the user the status of network devices. Control then returns to step 281 for ongoing processing in the network.

At step 286, if the automatic mode is not active, a supervised mode is instead active. At step 289, the infrastructure plan developed at step 285 may be presented to a user using the user interface. For example, the user interface may present graphical images showing what capacity units or other network elements are planned to be powered down, how traffic will be reconfigured before the powering-down, and other features as well. The user may edit the plan based on additional information or outside knowledge of the user.

If the user approves the plan at step 289, at step 290, the plan is reviewed again for compliance with engineering rules and 5G KPIs. If something in the plan is non-compliant, an iteration process may occur in which the user revises the plan to satisfy all relevant engineering rules and all relevant 5G KPIs. The plan may then be submitted to the controller at step 287 to implement the plan including load migration and powering down and powering up capacity units and other network equipment according to the infrastructure plan. In some embodiments, step 291 permits a user to interact with the plan to perform what-if testing and sensitivity analysis. The user may use the generative AI process to vary analysis of the network and to examine the effects on network behavior.

While for purposes of simplicity of explanation, the respective processes are shown and described as a series of blocks in FIG. 2B and FIG. 2D, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

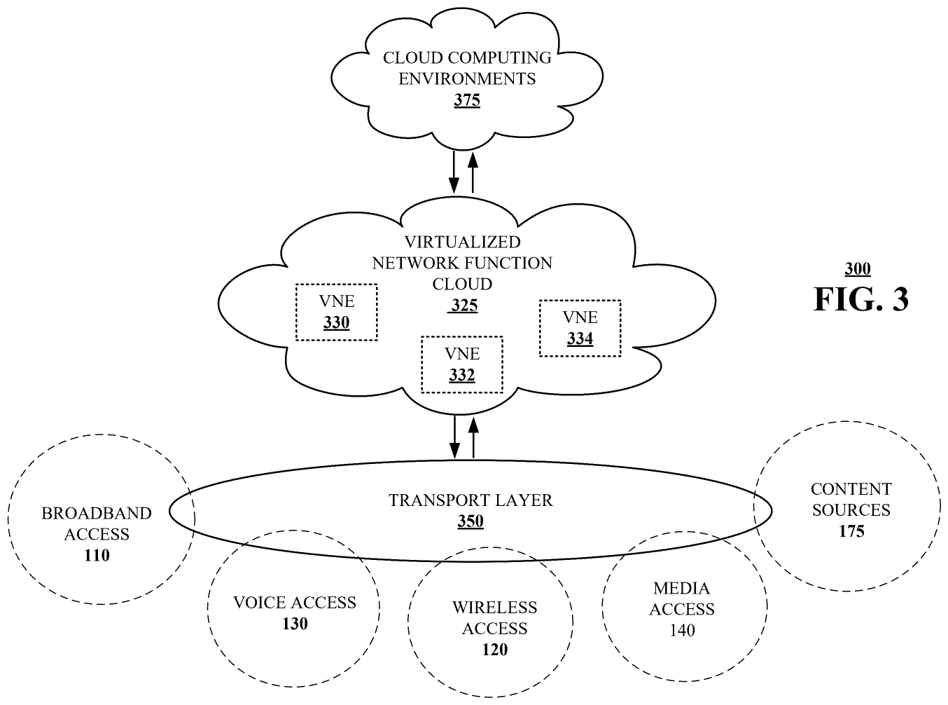

Referring now to FIG. 3, a block diagram is shown illustrating an example, non-limiting embodiment of a virtualized communication network 300 in accordance with various aspects described herein. In particular a virtualized communication network is presented that can be used to implement some or all of the subsystems and functions of system 100, the subsystems and functions of system 200, system 260, method 230, and method 280 presented in FIG. 1, FIG. 2A, FIG. 2B, FIG. 2C, FIG. 2D and FIG. 3. For example, virtualized communication network 300 can facilitate in whole or in part automating assignment of 5G workloads from regional distribution networks to network edge clouds using artificial intelligence and deep learning of network behavior and usage and based on 5G KPIs. Further, the virtualized communication network 300 can facilitate in whole or in part determining which network edge cloud devices need to be kept in service and which can be powered down gracefully to conserve power and cooling.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements—which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it is elastic: so, the resources are only consumed when needed. In a similar fashion, other network elements such as other routers, switches, edge caches, and middle boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized and might require special DSP code and analog front ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, S gateways, P gateways, broadband network gateways, IP edge routers for IP-VPN, Ethernet and other services, load balancers, distributers and other network elements. Because these elements do not typically need to forward large amounts of traffic, their workload can be distributed across a number of servers—each of which adds a portion of the capability, and which creates an elastic function with higher availability overall than its former monolithic version. These virtual network elements 330, 332, 334, etc. can be instantiated and managed using an orchestration approach similar to those used in cloud computer services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud or might simply orchestrate workloads supported entirely in NFV infrastructure from these third-party locations.

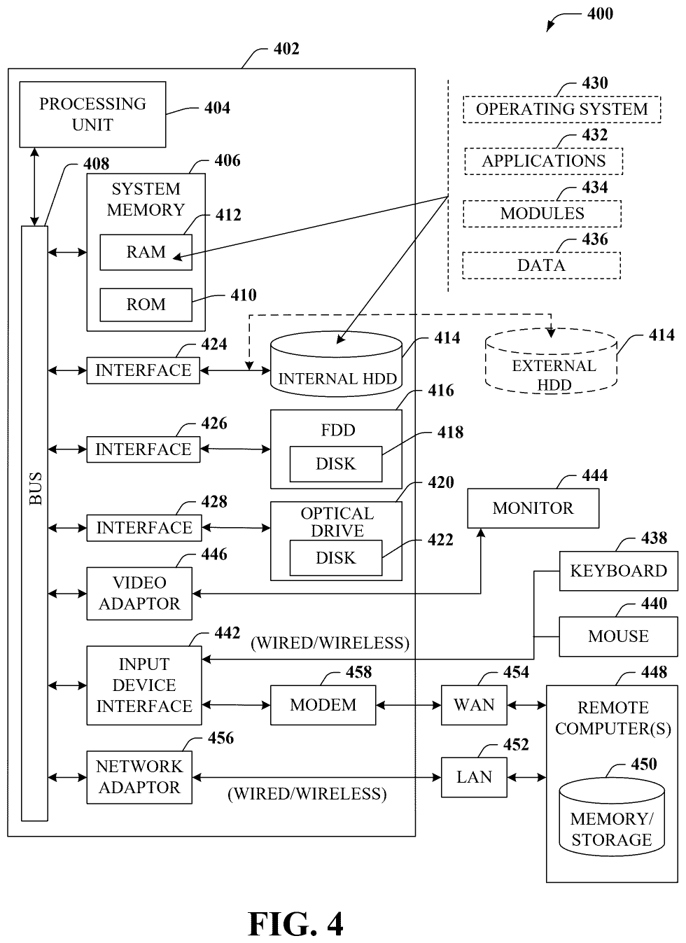

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part automating assignment of HB TAC 5G workloads from regional distribution networks to network edge clouds using artificial intelligence and deep learning of network behavior and usage to achieve compliance with 5G KPIs. Further, the computing environment 400 can facilitate in whole or in part determining which network edge cloud devices need to be kept in service and which can be powered down gracefully to conserve power and cooling.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are examples and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

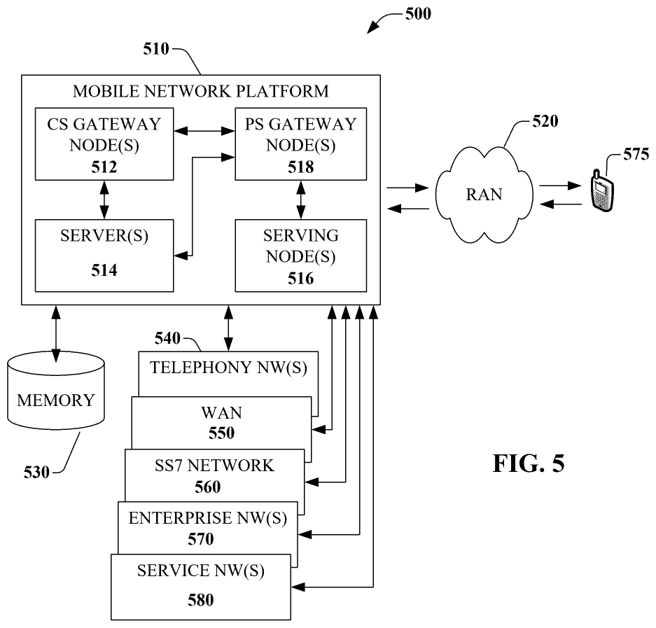

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part automating assignment of 5G workloads from regional distribution networks to network edge clouds using artificial intelligence and deep learning of network load and capacity usage trends and projections fully compliant with 5G KPIs. Further, the platform 510 can facilitate in whole or in part determining which network edge cloud devices need to be kept in service and which can be powered down gracefully to conserve power and cooling. In one or more embodiments, the mobile network platform 510 can generate and receive signals transmitted and received by base stations or access points such as base station or access point 122. Generally, mobile network platform 510 can comprise components, e.g., NEC nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technologies utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processors can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

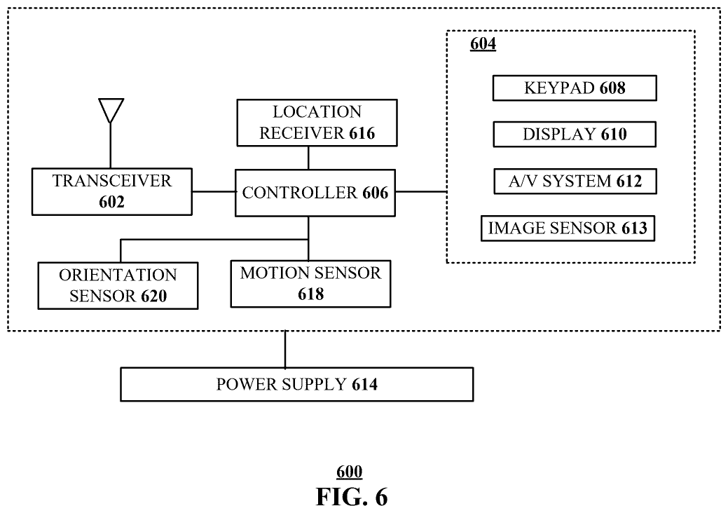

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, communication device 600 generates 5G workloads from regional distribution networks which are mapped to NEC nodes using artificial intelligence and deep learning of network behavior and usage and based on 5G KPIs. Further, the volume of 5G workload from such communication devices are used to determine which network edge cloud devices need to be kept in service and which can be powered down gracefully to conserve power and cooling.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, Wi-Fi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high-volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, Wi-Fi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices. Some of the embodiments described herein can also employ artificial intelligence (AI) to facilitate automating one or more features described herein.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria how to map 5G workload to NEC nodes for compliance with 5G KPIs, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A device, comprising:
a processing system including a processor; and
a memory that stores executable instructions that, when executed by the processing system, facilitate performance of operations, the operations comprising:
collecting information about network performance and capacity for a network, the network comprising a first plurality of network edge cloud nodes and a second plurality of service region devices, wherein service region devices of the second plurality of service region devices are configured to provide mobility network communication services to end users located in service regions associated with the service region devices, the end users accessing radio access networks (RAN) served by respective service region devices of the second plurality of service region devices, wherein the network edge cloud nodes are configured to process core network traffic associated with one or more respective radio access networks;
determining a set of key performance indicators (KPIs) for network performance for the service regions; and
automatically allocating traffic workload of a selected respective service regions to one or more designated network edge cloud nodes to satisfy one or more KPIs of the set of KPIs for respective service regions.

2. The device of claim 1, wherein the collecting information about network performance and capacity for the network comprises:
collecting information about current traffic workload of the respective service regions;
collecting information about current shared transport traffic capacity and usage; and
collecting information about current network capacity and usage in the designated network edge cloud nodes.

3. The device of claim 2, wherein the operations further comprise:
comparing the information about the current traffic workload in the respective service regions with the information about current network capacity and usage in a shared transport network and the designated network edge cloud nodes;
identifying violated KPIs of the set of KPIs, the violated KPIs having values out of an accepted range for a particular KPI of the set of KPIs; and
automatically reassigning respective service region network workload to one or more new designated network edge cloud nodes to correct the violated KPIs of the set of KPIs.

4. The device of claim 2, wherein the collecting traffic workload information about a network further comprises:
collecting network workload projection information about future network workload in the respective service regions;
identifying potentially violated KPIs of the set of KPIs, the potentially violated KPIs being at risk of having values out of an accepted range for a particular KPI of the set of KPIs based on the network workload projection information; and
automatically reassigning one or more selected respective service regions to one or more new designated network edge cloud nodes to correct the potentially violated KPIs of the set of KPIs.

5. The device of claim 1, wherein the operations further comprise:
processing the network performance and capacity information in an artificial intelligence module, the artificial intelligence module configured for automatically assessing and mapping communication traffic associated with respective service regions of the service regions to respective network edge cloud nodes of the first plurality of network edge cloud nodes to satisfy the one or more KPIs of the set of KPIs for the respective service regions.

6. The device of claim 5, wherein the automatically assessing and mapping communication traffic comprises:
associating a network workload of a selected respective service region with the one or more designated network edge cloud nodes; and
changing, by the artificial intelligence module, an association of the selected respective service region network workload from first designated network edge cloud nodes to second designated network edge cloud nodes in response to a failure to satisfy the one or more KPIs of the set of KPIs for the selected respective service region.

7. The device of claim 6, wherein the operations further comprise:
predicting, based on current network usage trends in a shared transport network and designated network edge cloud nodes and network workload projection information about future network workload in the respective service regions of the service regions, potentially violated KPIs of the set of KPIs; and
changing, by the artificial intelligence module, an association of the selected respective service regions from the first designated network edge cloud nodes to the second designated network edge cloud nodes in response to the potentially violated KPIs of the set of KPIs for the selected respective service regions.

8. The device of claim 1, wherein the operations further comprise:
providing a user interface, the user interface adapted for monitoring and control of network workload and capacity and usage in the network;
presenting, on the user interface, information about current network workload in the respective service regions;
presenting, on the user interface, information about current network capacity and usage in a shared transport network and designated network edge cloud nodes; and
receiving, from a user, control information to reassess and remap the selected respective service regions to the one or more designated network edge cloud nodes.

9. The device of claim 8, wherein the operations further comprise:
receiving, by an artificial intelligence module from the user interface, spoken direction or textual direction from the user; and
providing a visually meaningful response at the user interface for the user, the visually meaningful response illustrating one of current operating conditions in the network and potential operating conditions in the network.

10. The device of claim 9, wherein the operations further comprise:
receiving, by the artificial intelligence module from the user interface, spoken network reassessment and remapping commands or textual reassessment and reallocation commands from the user; and
automatically, by the artificial intelligence module, reassessing and reallocating the selected respective service regions to the one or more designated network edge cloud nodes.

11. A non-transitory machine-readable medium, comprising executable instructions that, when executed by a processing system including a processor, facilitate performance of operations, the operations comprising:
determining respective communication traffic workloads in respective network portions of a communication network, the communication network including service region devices establishing a radio access network in service regions to provide mobility network services to users in the service regions served by the service region devices;
determining current capacity and usage of core network equipment of the communication network, the core network equipment including a plurality of shared transport networks and network edge cloud nodes configured to provide core network services to the users in service regions, wherein each service region of the service regions is allocated to one or more network edge cloud nodes;
determining current network key performance indicators for communication traffic at the respective network portions of the communication network that governs the respective communication traffic workloads in the respective network portions; and
reallocating a service region from a current network edge cloud node to an available network edge cloud node based on available current capacity and usage of the available network edge cloud node to maintain the current network key performance indicators at acceptable values.

12. The non-transitory machine-readable medium of claim 11, wherein the operations further comprise:
predicting, based on historical information, future communication traffic workloads in the respective network portions of the communication network, forming predicted future communication traffic workloads;
identifying one or more at-risk service regions having a predicted future communication traffic workload likely to produce a future network key performance indicator at an unacceptable value at the predicted future communication traffic workload;
determining future capacity and usage of the core network equipment of the communication network, including identifying capacity-available network edge cloud node capable of handling future communication traffic of the one or more at-risk service regions; and
reallocating the one or more at-risk service regions to the capacity-available network edge cloud nodes.

13. The non-transitory machine-readable medium of claim 11, wherein the operations further comprise:
providing a user interface, the user interface adapted for monitoring and control of network workload and network capacity and usage in the communication network;
presenting, on the user interface, information about current network workload in the respective network portions;
presenting, on the user interface, information about current capacity and usage of core network equipment and current network key performance indicator status for the communication traffic at the respective network portions of the communication network; and
receiving, from a user, control information to reassess and remap the service regions from the current network edge cloud node to the available network edge cloud nodes.

14. The non-transitory machine-readable medium of claim 13, wherein the operations further comprise:
receiving, from the user, a request for analysis of a future network condition, the future network condition associated with a service region likely to experience degraded key performance indicators;
determining, by an augmentation module, identification of one or more service regions likely to experience degraded key performance indicators, wherein the determining is based on current core network capacity and usage information, future core network capacity and usage information, and current and future network traffic workloads for the service region; and
providing, to the user, a recommended network modification, wherein the recommended network modification specifies changes to one or more service regions or shared transport network elements or links or one or more network edge cloud nodes to produce a future network key performance indicator at an acceptable value.

15. The non-transitory machine-readable medium of claim 13, wherein the operations further comprise:
receiving, from the user interface, a spoken network reassess and remapping command or a textual reassessment and remap command from the user; and
automatically remapping a service region specified by the spoken network reassess and remapping command or the textual reassessment and remapping command from the user to the available network edge cloud nodes specified by the spoken network reassess and remapping command or the textual reassessment and remapping command.

16. A method, comprising:
monitoring, by a processing system including a processor, current communication traffic load, available capacity and usage of network equipment in a mobility network, the mobility network including a first plurality of service region devices providing a radio access network at respective service regions of a plurality of service regions and a second plurality of network edge cloud nodes providing core network functions for the mobility network, wherein each service region is allocated to one or more network edge cloud nodes for processing communication traffic of the each service region of the plurality of service regions;
identifying, by the processing system, possible traffic consolidations of network communication traffic on selected network equipment to enable powering down unneeded network equipment and compute equipment;
powering up, by the processing system, selected network equipment and compute equipment to begin processing communication traffic of the current communication traffic load;
shifting, by the processing system, the current communication traffic load on the selected network equipment and compute equipment, including monitoring key performance indicators for the current communication traffic load; and
selectively powering down, by the processing system, the unneeded network equipment and compute equipment to reduce overall power consumption by the mobility network.

17. The method of claim 16, wherein the identifying possible traffic consolidations of network communication traffic comprises:
identifying, by the processing system, a source network edge cloud node as a candidate for powering down, the source network edge cloud node handling a portion of the current communication traffic load in the mobility network;
identifying, by the processing system, a destination network edge cloud node having excess capacity suitable to handle the portion of the current communication traffic load; and
confirming, by the processing system, maintenance of key performance indicators for the portion of the current communication traffic load if the portion of the current communication traffic load is shifted from the source network edge cloud node to the destination network edge cloud node.

18. The method of claim 16, comprising:
identifying, by the processing system, a new network edge cloud node to provide core network functions for the mobility network;
allocating one or more service region devices to the new network edge cloud node;
deallocating two or more unneeded network edge cloud nodes form the one or more service region devices; and
powering down the two or more unneeded network edge cloud nodes.

19. The method of claim 16, comprising:
providing, by the processing system, a user interface, the user interface adapted for monitoring and control of network workload and network capacity and usage in the mobility network;
presenting, by the processing system, at the user interface, a graphical display of information about the possible traffic consolidations of the network communication traffic on the selected network equipment and compute equipment to enable the powering down of the unneeded network equipment and compute equipment; and
receiving, by the processing system, at the user interface from a user, one of a confirmation or a modification to the possible traffic consolidations of the network communication traffic.

20. The method of claim 16, comprising:
detecting, by the processing system, a change in an ongoing communication traffic load;
powering up, by the processing system, the unneeded network equipment and compute as reactivated network equipment; and
shifting, by the processing system, a portion of the ongoing communication traffic load on the selected network equipment and compute equipment to the reactivated network equipment, wherein the shifting the portion of the ongoing communication traffic load comprises predicting key performance indicator values for shifted traffic and confirming that predicted key performance indicator values have acceptable values for the shifted traffic.
